(19) United States
(12) Patent Application Publication
(10) Pub. No.: US 2007/0044262 A1
(43) Pub. Date: Mar. 1, 2007

(54) Sealant hand tools

(76) Inventor: George H. Wakat, St. Paul Park, MN (US)

Correspondence Address: ROBERT J JACOBSON PA, 650 BRIMHALL STREET SOUTH, ST PAUL, MN, 551161511, US

(21) Appl. No.: 11/510,022

(22) Filed: Aug. 26, 2006

Related U.S. Application Data
(60) Provisional application No. 60/711,521, filed on Aug. 27, 2005.

(51) Int. Cl. B05C 17/10

(52) U.S. Cl. 15/235.7; 15/235.3

(57) ABSTRACT

A hand tool set having a) a first hand tool with a knife end and a claw end for preparing surfaces for better accepting putty or putty like materials and b) a second hand tool that smoothes and shapes a seal or sealant placed in the prepared surface. The first hand tool includes a base metal piece. The second hand tool includes a piece of flat plastic that includes first and second heads, where each of the heads includes a convex smooth edge to smooth and shape sealant to have a concave profile. At least a section of the main body portion of each of the first and second tools is sandwiched between two foam pieces that act as a handle or grip for the hand tool.

This application claims the benefit under 35 U.S.C. 119(e) of U.S. Provisional Patent Application No. 60/711,521 filed Aug. 27, 2005, which is hereby incorporated by reference in its entirety into this application.

### FIELD OF THE INVENTION

The present invention generally relates to hand tools, particularly to hand tools for digging out putty and for smoothing and shaping sealant, and specifically to a hand tool set that includes a putty digging hand tool having a pointed bent end and a sharpened knife end and a hand tool having shaping ends for smoothing and shaping sealant such that the resulting shaped sealant includes a concave profile.

### BACKGROUND OF THE INVENTION

Most hand tools for smoothing and shaping sealant leave the seal or sealant having a convex or bulging profile. This bulging profile is illustrated in the present drawings in FIGS. 1D, 2C and 3C labeled as prior art. The profile or shape of such a seal allows moisture, mold, mildew, and bacteria to accumulate around the seal. A seal having such a profile or shape is relatively inflexible because such a seal is relatively thick. A seal having such a profile or shape tends to pull away from the surfaces to which it should adhere rather than move and flex with the adjoining surfaces.

### SUMMARY OF THE INVENTION

A feature of the present invention is the provision in a hand tool set for working putty, of one hand tool being a putty digging hand tool and of another hand tool being a smoothing and shaping sealant hand tool.

Another feature of the present invention is the provision in a hand tool set for working putty, of a first hand tool being a smoothing and shaping sealant hand tool with a first particular combination of ends or tips for shaping sealant, of a second hand tool being a smoothing and shaping sealant hand tool with a second particular combination of ends or tips for shaping sealant, and of a third hand tool being a smoothing and shaping sealant hand tool with a third particular combination of ends or tips for shaping sealant.

Another feature of the present invention is the provision in a hand tool for working putty, of one hand tool having a pointed bent or clawed end and a knife or chisel end.

Another feature of the present invention is the provision in a hand tool for working putty, of one hand tool having two shaping ends.

Another feature of the present invention is the provision in a hand tool system for working putty, of one hand tool having a pointed bent or clawed end and a knife or chisel end, of another hand tool having two shaping ends, and of each of the hand tools having resilient foam coverings that extend over the length of each of the hand tools, that extend on each sides of the hand tools, and that terminate short of each of the working ends of the hand tools.

A feature of the present invention is the provision in a hand tool for smoothing and shaping sealant, of a body having at least a first head, of a grip engaging at least a section of the body, and of the first head having a smooth edge portion to smooth and shape sealant.

Another feature of the present invention is the provision in such a hand tool for smoothing and shaping sealant, of the smooth edge portion including a convex smooth edge portion running generally laterally such that a concave impression is left in the sealant being smoothed and shaped.

Another feature of the present invention is the provision in such a hand tool for smoothing and shaping sealant, of the body having a second head, and of the first and second heads being generally on the same axis.

Another feature of the present invention is the provision in such a hand tool for smoothing and shaping sealant, of the convex smooth edge portions on the first and second heads having different radii to leave impressions of concave shapes having greater and lesser radii.

Another feature of the present invention is the provision in such a hand tool for smoothing and shaping sealant, of the body being a flat piece of plastic.

Another feature of the present invention is the provision in such a hand tool for smoothing and shaping sealant, of the flat piece of plastic being resilient.

Another feature of the present invention is the provision in such a hand tool for working putty, such as digging out putty or smoothing and shaping sealant, of the grip being resilient such that the grip is compressible by hand.

Another feature of the present invention is the provision in such a hand tool for smoothing and shaping sealant, of the grip confronting each of the first and second heads such that fingers may grip the tool relatively closely to the heads, and of the grip being spaced from each of the first and second heads such that an outer section of the main body portion extends beyond the grip and forms a transition of a visible and defined juncture with each of the first and second heads whereby the first and second heads are distinctly defined for a user.

Another feature of the present invention is the provision in such a hand tool for smoothing and shaping sealant, of the body including an elliptical portion sandwiched by two grip portions formed in the shape of an ellipse to provide an aesthetic look to the hand tool and to dispose end portions of the grip portions relatively closely to the heads of the relatively elongate hand tool.

Another feature of the present invention is the provision in a method for forming a concave seal, of selecting a hand tool having convex smooth edge, introducing sealant into an elongate space, and then simultaneously smoothing the sealant in the elongate space and forming a concave impression in the elongate space with the convex smooth edge.

Another feature of the present invention is the provision in a hand tool set, of a set of caulking hand tools removably engaged to each other such as via a key ring or lace, where the rounded tip of each of the hand tools of such set includes a different radius.

Another feature of the present invention is the provision in a hand tool set, of a set of glazing hand tools removably engaged to each other such as via a key ring or lace, where the rounded tip of each of the hand tools of such set includes a different radius.

An advantage of the present invention is a longer lasting seal. One feature contributing to this advantage is the convex edge of the head that leaves the concave impression in the seal. A concave shape to a seal minimizes the accumulation of moisture, mildew, salmonella and bacteria around the seal. A concave shape to a seal provides a relatively thin and thus relatively flexible seal.

Another advantage of the present invention is that seals can be shaped quickly and easily. One feature contributing to this advantage is the provision of first and second heads having concave smooth edges of different radii such that more seals of different sizes may be profiled with just one hand tool.

Another advantage is that all of the hand tools are relatively light in weight. The main body is formed of lightweight plastic or a thin piece of metal. The grip is formed of lightweight foam.

Another advantage is that all of the hand tools are comfortable to hold and easy to grip. Two pieces of foam sandwich the main body portion of each of the hand tools.

Another advantage is that the heads of all of the hand tools are easy to manipulate. One feature contributing to this advantage is that the grip confronts the heads such that the fingers of the user can manipulate such hand tool at a location relatively close to the tip or end that is working the putty.

Another advantage is that the hand tools are inexpensive to manufacture. The body is preferably formed of plastic or metal. The grip is preferably formed of plastic.

Another advantage is that the hand tools are easily washed of sealant. The plastic or metal body has relatively slippery and flat surfaces that can be cleaned relatively easily of sealant.

Another advantage is that the hand tools are sufficiently inexpensive to be disposable.

### BRIEF DESCRIPTION OF THE DRAWINGS

FIG. 1A is a perspective view of one embodiment of the present sealant smoothing and shaping hand tool.

FIG. 1B is a section view of the hand tool at lines 1B-1B of FIG. 1A.

FIG. 1C is an perspective, environmental, somewhat top view of the hand tool of FIG. 1A in use forming an impression in sealant and simultaneously pushing the bead of sealant into place.

FIG. 1D is a section view of a prior art seal with a convex impression.

FIG. 1E is a section view of a seal for an expansion joint, where the seal includes a concave impression that is formed by the hand tool of FIG. 1A.

FIG. 2A is a perspective view of another embodiment of the present sealant smoothing and shaping hand tool.

FIG. 2B is an perspective, environmental, somewhat top view of the hand tool of FIG. 2A in use forming an impression in sealant and simultaneously pushing the sealant into place.

FIG. 2C is a section view of a prior art seal with a convex impression.

FIG. 2D is a section view of a seal for a juncture about tubs, siding shower bases or windows, where the seal includes a concave impression that is formed by the hand tool of FIG. 2A.

FIG. 3A is a perspective view of another embodiment of the present sealant smoothing and shaping hand tool.

FIG. 3B is an perspective, environmental, somewhat top view of the hand tool of FIG. 3A in use forming an impression in sealant and simultaneously pushing the sealant into place.

FIG. 3C is a section view of a prior art seal with a convex impression.

FIG. 3D is a section view of a seal for a juncture about a vanity or sink, where the seal includes a concave impression that is formed by the hand tool of FIG. 3A.

FIG. 4A shows a top view of the hand tool embodiment of FIG. 1A.

FIG. 4B shows a top view of the hand tool embodiment of FIG. 2A.

FIG. 4C shows a top view of the hand tool embodiment of FIG. 3A.

FIG. 5A is a side view of another embodiment of the present hand tool, showing a rigid member sandwiched by a pair of resilient foam coverings, with the rigid member having a clawed end and a chisel end.

FIG. 5B is a top view of the hand tool of FIG. 5A.

FIG. 6 is a top, partially phantom view, of a caulking tool hand set utilizing a different embodiment of the invention of FIG. 1

FIG. 7 is a top, partially phantom view, of a glazing tool hand set utilizing a different embodiment of the invention of FIG. 1.

### DESCRIPTION OF THE PREFERRED EMBODIMENT

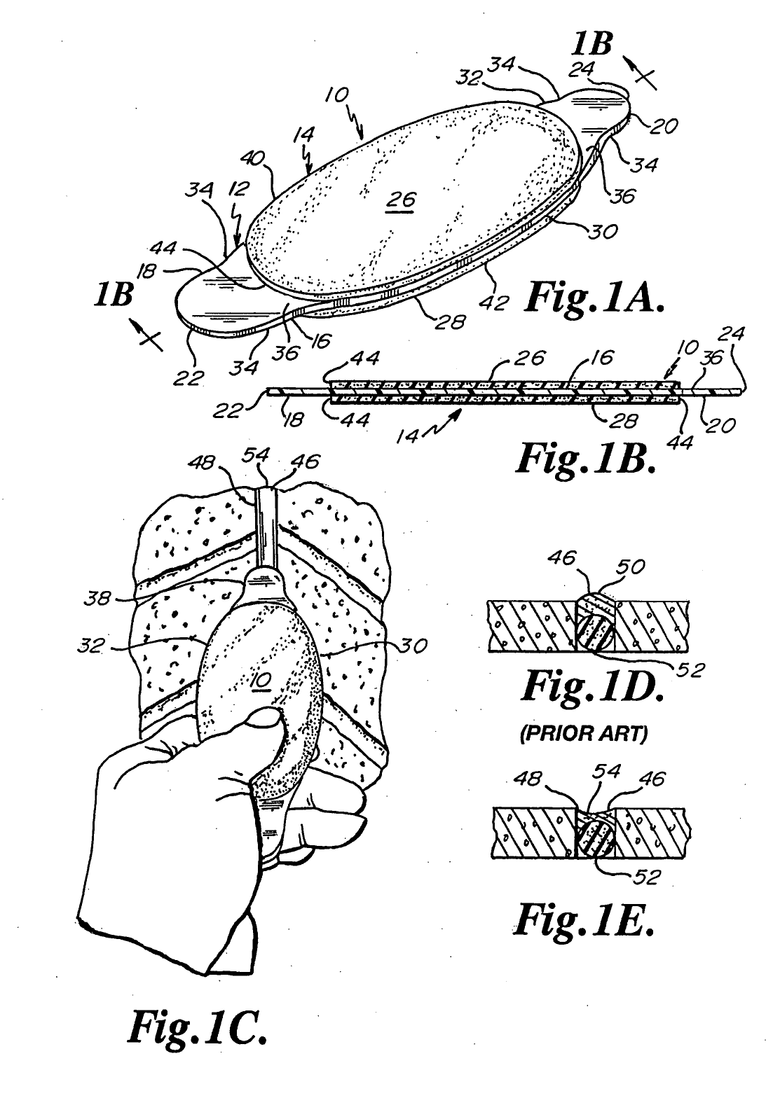

The present sealant smoothing and shaping hand tool is shown in FIG. 1A with the reference number 10. Hand tool 10 generally includes a body 12 and a grip 14. The body 12 includes a main body portion 16, a first head 18, and a second head 20. First head 18 includes a smoothing and shaping edge or rounded tip 22. Second head 20 includes a smoothing and shaping edge or rounded tip 24. The grip 14 includes a first grip portion 26 and a second grip portion 28.

With more specificity, body 12 is preferably a flat piece of plastic with flat and smooth upper and lower surfaces. The flat piece of plastic is relatively thin, semi-rigid and resilient such that the body 12 is relatively thin, semi-rigid and resilient and such that the main body portion 16, first head 18 and second head 20 are relatively thin, semi-rigid and resilient. Less preferred materials for the body 12 are metal and wood.

Body 12 includes the main body portion 16. The main body portion 16 forms a portion of an ellipse and includes opposing elliptical edges 30, 32. Each of the elliptical edges 30, 32 terminate at a transition or juncture 34 with one of the heads 18, 20, which transition or juncture 34 defines the beginning of the respective head 18 or 20.

Main body portion 16 includes an outer section 36 that is not sandwiched or covered by the grip portions 26, 28. This outer section 36 remains exposed to aid in better defining the heads 18, 20 for the user and such that the transitions or junctures 34 are well visible and not obscured by the grip portions 26, 28 and such that the elliptical grip portions 26, 28 cover much, but not all, of the main body portion 16. Alternatively, the main body portion may be defined as that portion immediately covered by the grip portions 26, 28, with any exposed portion of the body 12 being referred to as head 18 or 20.

Heads 18 and 20 are integral and one-piece with the main body portion 16, including the outer section 36. The heads 18 and 20 extend from the outer section 36 at the transitions or junctures 34. Each of the heads 18, 20 includes a linear edge portion 38 extending from its respective transition or juncture 34, which leads into the smoothing and shaping edge 22 or 24.

The smoothing and shaping edges 22 and 24 are convex on heads 18 and 20 and form concave impressions in sealant being worked upon. On hand tool embodiment 10, smoothing and shaping edge 22 on head 18 has a relatively great radius and smoothing and shaping edge 24 on head 20 has a relatively small radius to make concave impressions having greater and smaller radii.

Each of the smoothing and shaping edges 22 and 24 includes a thickness. The thickness is defined by the distance between the upper and lower surfaces of the body 12. As to any contour or shape of the edges 22 and 24 in the direction between the upper and lower surfaces of the body 12, such a contour or shape may be flat or may be slightly recessed so as to be slightly concave or may have a slight bulge so as to be slightly convex.

Grip 14 refers to grip portions 26 and 28. Each of grip portions 26 and 28 forms an ellipse having an elliptical endless edge 40. Side portions 42 of the elliptical endless edge 40 lie flush with portions of the elliptical edges 30, 32 of the main body portion 16 of the body 12. End portions 44 of the elliptical endless edge 40 confront and are spaced from respective heads 18, 20. End portions 44 terminate short of heads 18, 20 and permit outer sections 36 of the main body portion 16 to remain exposed to the eye. End portions 44 are sufficiently close to and sufficiently confront heads 18 and 20 and their smoothing and shaping edges 22, 24 to permit a pair of fingers or a hand to manipulate the tool 10 to have relatively great control over the smoothing and shaping edges 22 and 24.

Grip portions 26 and 28 are resilient. Grip portions 26 and 28 are compressible by hand or by the fingers. Grip portions 26 and 28 have a surface that is somewhat rough so as to be relatively nonslip to the touch. Grip portions 26 and 28 are preferably formed of a foam, and more preferably formed of a closed cell foam. Grip portions 26 and 28 are relatively flat, as shown in FIG. 1B, and directly engage the main body portion 16 with the exception of the outer section 36. Grip portions 26 and 28 may be glued to portions of the upper and lower faces of the main body portion 16. The thickness of each of the grip portions 26 and 28 is generally the same as the thickness of the body 12.

FIG. 1B illustrates shows a cross section of the hand tool of FIG. 1A and shows that the body 12 including the main body portion 16 and heads 18 and 20 are relatively flat. FIG. 1B further shows that the grip portions 26 and 28 are relatively flat. As a whole, hand tool 10 is relatively thin.

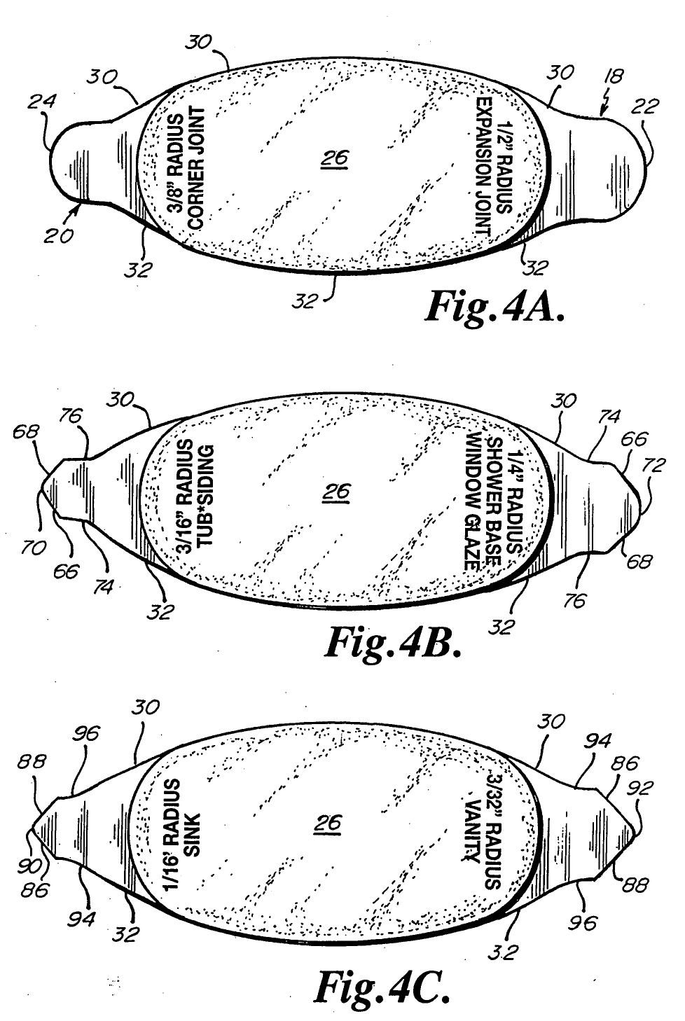

FIG. 1C shows the hand tool 10 in use for smoothing and shaping the sealant 46 of an expansion joint 48. As shown in FIG. 4A, whereas edge portion 22 preferably has a one-half inch radius and is preferably used for an expansion joint, edge portion 24 preferably has a three-eighth inch radius and is preferably used on sealant of a corner joint.

FIG. 1D shows a prior art seal 50 having a convex impression in an expansion joint having a foam backer rod 52.

FIG. 1E shows a seal 54 having a concave impression formed by one of the smoothing and shaping edges 22, 24.

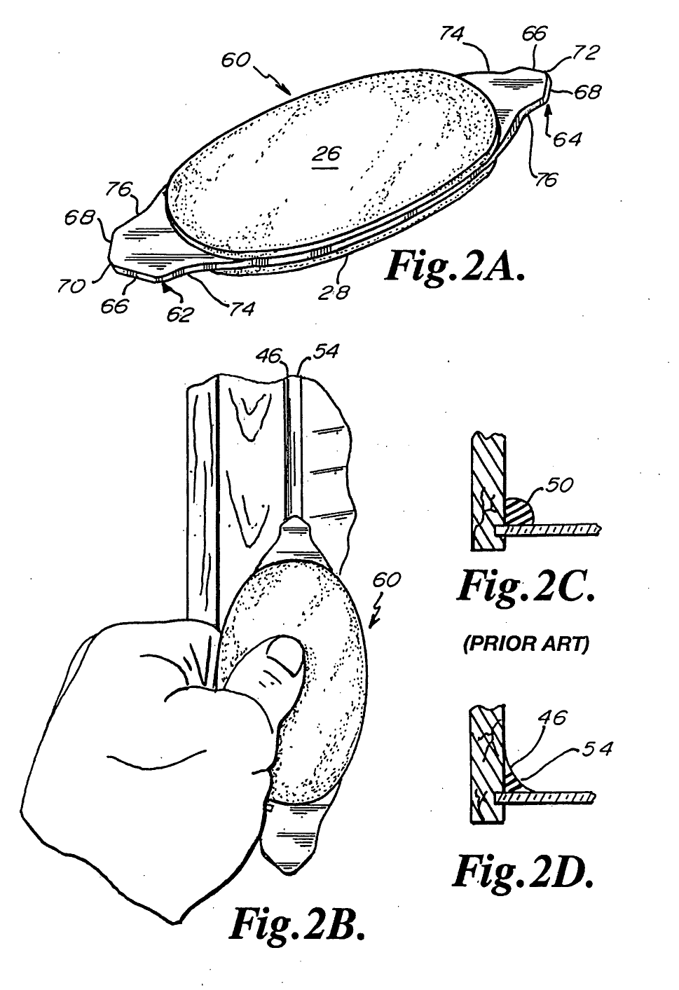

FIG. 2A shows another embodiment of the present sealant smoothing and shaping hand tool and is indicated by the reference number 60. Hand tool 60 includes all of the features of hand tool 10, except for the particular structure of the first and second heads. Here, hand tool 60 includes a first head 62 and a second head 64. Each of the first and second heads 62, 64 includes a pair of linear edge portions 66, 68 extending at ninety degrees relative to each other. Disposed between the linear edge portions 66, 68 on the first head 62 is a convex smoothing and shaping edge portion or rounded tip 70. Disposed between the linear edge portions 66, 68 on the second head 64 is a convex smoothing and shaping edge portion or rounded tip 72. Edge portions 70 and 72 have different radii. Edge portion 70 preferably has a three-sixteenth inch radius and is preferably used for sealant found about tubs and in siding. Edge portion 72 preferably has a one-quarter inch radius and is preferably utilized for sealant of shower bases and window glazing. Each of the heads 62 and 64 further are defined by transition edge portions 74, 76 that lead from the elliptical edges 30, 32, into the linear edge portions 66, 68.

FIG. 2B shows the hand tool 60 in use for smoothing and shaping the sealant 46 of window glazing.

FIG. 2C shows a prior art seal 50 having a convex impression.

FIG. 2D shows a seal 54 having a concave impression formed by one of the smoothing and shaping edges 70, 72 of hand tool 60.

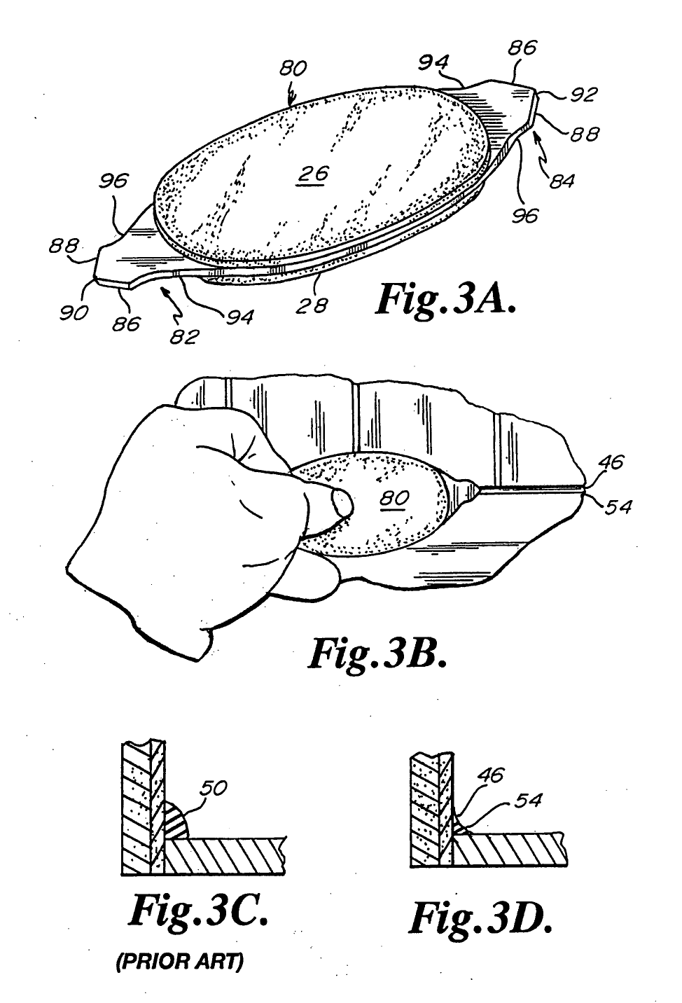

FIG. 3A shows another embodiment of the present sealant smoothing and shaping hand tool and is indicated by the reference number 80. Hand tool 80 includes all of the features of hand tool 10, except for the particular structure of the first and second heads. Here, hand tool 80 includes a first head 82 and a second head 84. Each of the first and second heads 82, 84 includes a pair of linear edge portions 86, 88 extending at ninety degrees relative to each other. Disposed between the linear edge portions 86, 88 on the first head 82 is a convex smoothing and shaping edge portion or rounded tip 90. Disposed between the linear edge portions 86, 88 on the second head 84 is a convex smoothing and shaping edge portion or rounded tip 92. Edge portions 90 and 92 have different radii. Edge portion 90 preferably has a one-sixteen inch radius and is preferably utilized for sealant about a sink. Edge portion 92 preferably has a three-thirtyseconds inch radius and is preferably used for sealant found about vanities. Each of the heads 82 and 84 further are defined by transition edge portions 94, 96 that lead from the elliptical edges 30, 32, into the linear edge portions 86, 88.

FIG. 3B shows the hand tool 80 in use for smoothing and shaping the sealant 46 of, for example, sinks.

FIG. 3C shows a prior art seal 50 having a convex impression.

FIG. 3D shows a seal 54 having a concave impression formed by one of the smoothing and shaping edges 90, 92 of hand tool 80.

In operation, sealant is introduced with a relatively light amount of pressure into a joint or into a corner or into another type of structure. Then, relatively soon after the sealant has been so introduced, one of the smoothing and shaping edges of one of the hand tools is placed into or partially into the sealant and drawn along the sealant to apply a relatively great amount of pressure to the bead of sealant to push the sealant into the joint or juncture and to simultaneously create a concave impression in the sealant. Between applications or after a job is complete, the hand tool may be cleaned of sealant with a cloth. Or, after use, the hand tool may be thrown away.

It should be noted that the grip 14 (or grip portions 26, 28) may be formed of a polyethylene foam such as ethylene vinyl acetate.

It should be noted that the body 12, including the main body portion, the outer section 36, and the first and second heads 18 and 20 may be formed of a high density polyethylene.

It should be noted that materials selected for the grip 14 and body 12, such as polyethylene foam and high density polyethylene, are resistant to chemicals, solvents, oil, and hydraulic fluid.

It should be noted that the materials selected for the grip 14 and body 12, such as polyethylene foam and such as high density polyethylene, are selected so as to minimize the sticking of sealant or caulk, so as to maximize the release of caulk (wet or dry), and so as to minimize drag.

It should be noted that the present hand tools 10, 60 and 80 minimize or outright eliminate the use of “slippery” chemicals that are placed on caulk prior to bringing pressure to bear on the caulk, such as with a thumb. For example, Windex® is applied by some to caulk prior to bringing a sliding pressure to bear on the caulk. Another example, is Windex® or water on a terry cloth used for wiping or bringing pressure to bear upon caulk.

It should be noted that “convex” means to have a surface or boundary that curves or bulges outwardly, such as the exterior surface of a sphere. It should be noted that the curving or bulging outwardly is not necessarily a circular portion or a spherical portion.

It should be noted that “concave” means to have a surface or boundary that curves or bulges inwardly, such as the interior surface of a sphere. It should be noted that the curving or bulging inwardly is not necessarily a circular portion or a spherical portion.

It should be noted that side edges of the heads may be used for wiping sealant after an impression has been formed in the sealant. These edges includes edges 32, 34, 66, 68, 74, 76, 86, 88, 94 and 96.

It should be noted that each of the hand tools 10, 60 and 80 includes a body 12 and a grip 14, wherein the grip 14 includes a first grip portion 26 and a second grip portion 28. In each of the hand tools 10, 60, and 80, body 12 is disposed in a first plane, first grip portion 26 is disposed in a second plane, and second grip portion 28 is disposed in a third plane. The first, second and third plane run parallel to each other. The first plane is sandwiched between the second and third planes. Such first, second and third planes are also found in hand tool 98, with the exception of the angled digging portion 116.

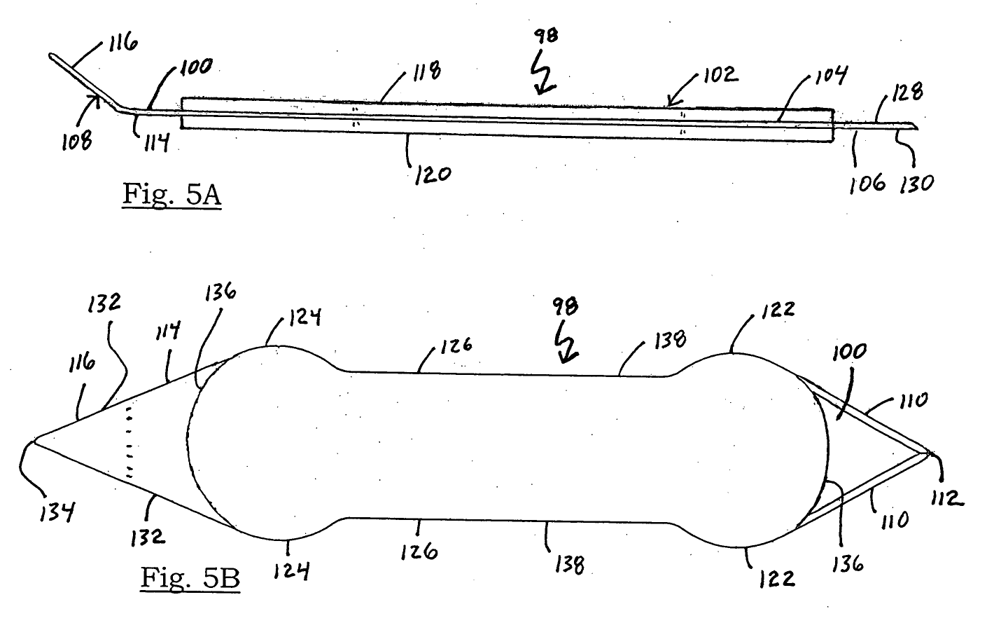

The present invention includes a hand tool 98, as shown in FIGS. 5A and 5B. Hand tool 98 is a putty digging hand tool. Hand tool 98 generally includes a main body 100 and a grip 102. Main body 100 includes a main body portion 104, a first head 106, and a second head 108. First head 106 includes a pair of knife edges or blades 110 that are sharpened and merge at a sharp pointed tip 112. Second head 108 includes a base portion 114 disposed in the same plane as main body portion 104 and an angled tipped portion or claw 116. Grip 102 includes a first grip portion 118 and a second grip portion 120.

With more specificity, main body 100 is preferably a rigid, though resilient, piece of metal, such as stainless steel, with flat and smooth upper and lower surfaces, and the main body 100 is flat with the exception of the angled head portion 116. The metal piece is relatively thin, which tends to lend it some resiliency, such that the main body portion 104, first head 106 and second head 108 are relatively thin, rigid and somewhat resilient. If desired, body 100, including the main body portion 104, first head 106 and second head 108 may be formed of plastic.

Main body 100 includes the main body portion 104. The main body portion 104 is the portion sandwiched directly between grip portions 118 and 120. As such, main body portion 104 includes a pair of curved opposing edges 122 leading into first head portion 106 and a pair of curved opposing edges 124 leading into second head portion 108. Each of the curved edges 122, 124 forms a portion of a circle. Main body portion 104 is further defined by a-pair of opposed linear edges 126 running to and between respective curved edges 122 and 124. Linear edges 126 are set inwardly from outer portions of edges 122, 124 so as to lend a dog bone shape to the main body portion 104.

The portions of the main body 100 that are not covered by the grip portions 118 and 120 are the first and second heads 106, 108. The heads 106 and 108 are well visible and not obscured by the grip portions 118, 120. Heads 106 and 108 are integral and one-piece with the main body portion 104.

First head 106 includes the knife edges or blades 110. Each of the knife edges or blades 110 extends tangentially from a respective curved edge 122 of main body portion 104. The knife edges 110 taper toward each other and terminate at the sharp tip 112. Each of the knife edges 110 extends from an upper surface 128 of first head 106 to a lower surface 130 of the first head 106. If desired, each of the surfaces 128, 130 may be sharpened to produce a knife edge or blade disposed between the upper and lower surfaces 128, 130.

As indicated above, second head 108 includes base portion 104 and angled tipped portion 116. Base portion 104 and angled tipped portion 116 share a pair of tapering edges 132 that extend tangentially from curved edges 124 and that terminate in a sharp tip 134. Angled tip portion 116 is preferably set between about 10 degrees and 60 degrees relative to base portion 104, more preferably between about 20 and 50 degrees relative to base portion 104, and most preferably between about 28 and 47 degrees relative to base portion 104. Tip 134 terminates in a plane disposed beyond a plane in which grip portion 118 lies.

Each of the heads of each of the tools 10, 60, 80 and 98 preferably includes a length between about 10% and about 33% the length of the tool as a whole (including the heads) and more preferably between about 10% and about 25% the length of the tool as a whole (including the heads).

Grip 102 refers to grip portions 118 and 120. As with the grip portions of hand tools 10, 60 and 80, each of the grip portions 118 and 120 of hand tool 98 are identical in shape. When viewed from above, the shape of each of the grip portions 118 and 120 is identical to the shape of the main body portion 104 such that each of the grip portions 118, 120 includes a pair of opposing C-shaped curved edges 136 that run flush with curved edges 122 and 124 and such that each of the grip portions 118, 120 includes a pair of opposing linear edges 138 that run flush with linear edges 126 of main body portion 104 so as to lend a dog bone shape to each of the grip portions 118 and 120.

The C-shaped edges 136 define in part the first and second heads 106 and 108. The C-shaped edges 136 confront and are spaced from sharp tips 112 and 134 such that fingers close to the C-shaped edges 136 can reside on the grip 102 while at the same time reside relatively close to heads 106 and 108 for control of the heads 106 and 108 and their respective sharp tips 112 and 134.

Grip portions 118 and 120 are resilient. Grip portions 118 and 120 are compressible by hand or by the fingers. Grip portions 118 and 120 have a surface that is somewhat rough so as to be relatively nonslip to the touch. Grip portions 118 and 120 are preferably formed of a foam, and more preferably formed of a closed cell foam. Grip portions 118 and 120 are relatively flat and directly engage the main body portion 104. Grip portions 118 and 120 may be glued to the upper and lower faces 128, 130 of the main body portion 104. The thickness of each of the grip portions 118 and 120 is generally about three times the thickness of the main body 100.

First head 106, with the pair of knife blades or edges 110, is in the nature of a chisel end that digs in, scrapes and lifts up putty caulk, window glaze or grout. First head or chisel end 106 also works for scraping paint or excess sealant from glass, tubs, tiles or ceramic surfaces.

Second head 108 is in the nature of a claw or corner claw. Second head or claw 108 pulls putty, caulk or window glaze out of corners and digs out grout between ceramic tile. Second head or claw 108 further may prepare cracks in plaster, sheetrock or cement for repair by the steps of digging into a crack with the claw 108 to create a V-shaped valley. The V-shaped valley creates a larger surface area to which crack filler can adhere. Such also prevents the filler from “mounding” (bulging out) over the crack.

It should be noted that each of the heads of each of the tools 10, 60, 80 and 98 includes a pair of edges that run tangentially into edges of the grip portions. Such edges include edges 30 and 32 of hand tools 10, 60 and 80 that run into edges 40, and edges 110 and edges 132 of hand tool 98 that run into C-shaped edges 136.

It should be noted that each of the heads of each of the tools 10, 60, 80 and 98 includes C-shaped edges. As to hand tools 10, 60, and 80, such a C-shaped edge forms a portion of elliptical edge 40 and can be seen to be the end portions of endless elliptical edges 40 that confront their respective heads.

It should be noted that one preferred set of hand tools includes hand tools 10, 60, 80 and 98. Another preferred set of hand tools includes hand tools 10, 60, and 80. Another preferred set of hand tools includes a) one or more hand tools selected from the group of hand tool 10, hand tool 60 and hand tool 80, and b) hand tool 98. Generally, in operation, tool 98 prepares a surface, such as a relatively hard surface such as sheet rock or hardened or cured putty, and one or more of hand tools 10, 60, and 80 repairs the surface by acting upon a relatively soft surface, with the relatively soft surface being sealant that has yet to harden and that is smoothed and shaped.

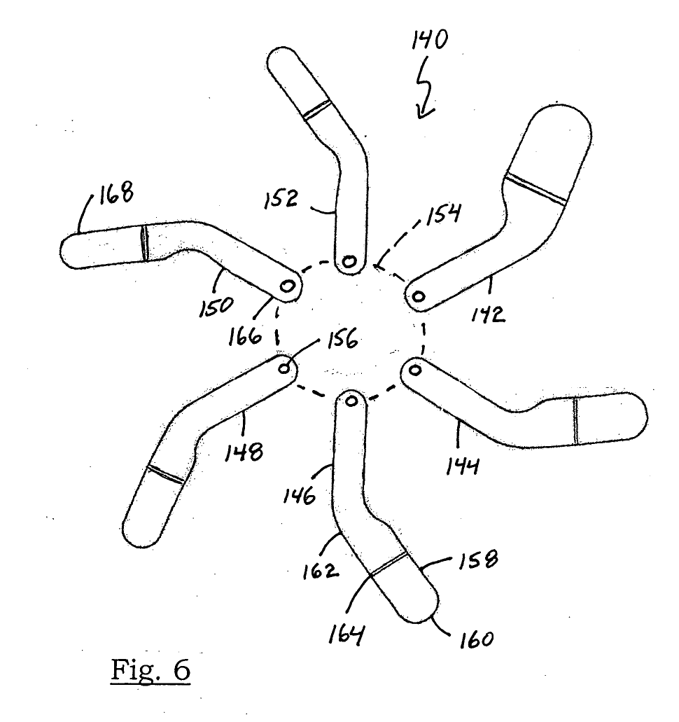

FIG. 6 shows a set 140 of caulking hand tools 142, 144, 146, 148, 150 and 152 removably engaged to each other via a fastener 154. Fastener 154 may be a key ring, a shoelace, a strip of leather or other fastener that can be quickly and readily opened to selectively take any of the hand tools 142, 144, 146, 148, 150 and 152 off of the fastener 154. Fastener 154 can directly or indirectly engage a hole 156 formed in each of the hand tools of set 140. Or fastener 154 can directly or indirectly engage each of the hand tools of set 140 in another way such that the tools of set 140 can selectively be removed from the fastener 154.

Each of the hand tools of set 140 includes a body 158 having a rounded tip 160. Each of the hand tools of set 140 further includes a grip 162 sandwiching body 158.

Body 158 includes the features of body 12 except that body 158 has a single head 168, except that body 158 is set at an angle instead of being elliptical, and except that body 158 includes hole 156. As to the angle of body 158, the angle can be referred to as a relatively wide V-shape or a lazy L-shape. Such an angle is preferably between about 10 degrees and 45 degrees. Like body 12, body 158 is resilient such that body 158 can be flexed somewhat when gripping and bending ends 160 and 166 relative to each other, and body 158 is preferably formed of a plastic.

Grip 162 includes the features of grip 14, except that grip 162 extends wholly to one end of its respective tool (end 166), except that grip 162 is set at an angle instead of being elliptical, except that grip 162 includes hole 156, and except that grip 162 includes a tapered portion 164. Like grip 14, grip 162 is engaged on both sides or faces of body 158, is preferably formed of a closed cell foam so as to be resilient and compressible, confronts rounded tip 160, and is spaced from rounded tip 160.

It should be noted that each of the grips 162, like grips 14 of different hand tools, can be color coded, with respective colors being associated with respective radii of the rounded tip 160. In other words, each of the tools of hand tool set 140 includes a rounded tip 160 with a different radius and each of the tools of hand tool set 140 includes a grip 162 of a different color.

It should be noted that each of the hand tools of set 140 includes an operating end (rounded tip or proximal end 160) and a fastened end (distal or apertured end 166). Ends 160, 166 are not aligned and are not found on the same axis. In other words, a portion of the grip 162 is disposed on an axis that is set at an angle from an axis of a head 168 of body 158. Such provides a more efficient caulking action where relatively less pressure is exerted for operation (as compared with a glazing action where relatively greater pressure is exerted for operation).

It should be noted that each of the hand tools of set 140 can be used for caulking (or another operation) while engaged on fastener 154 or while disengaged from fastener 154 and standing alone.

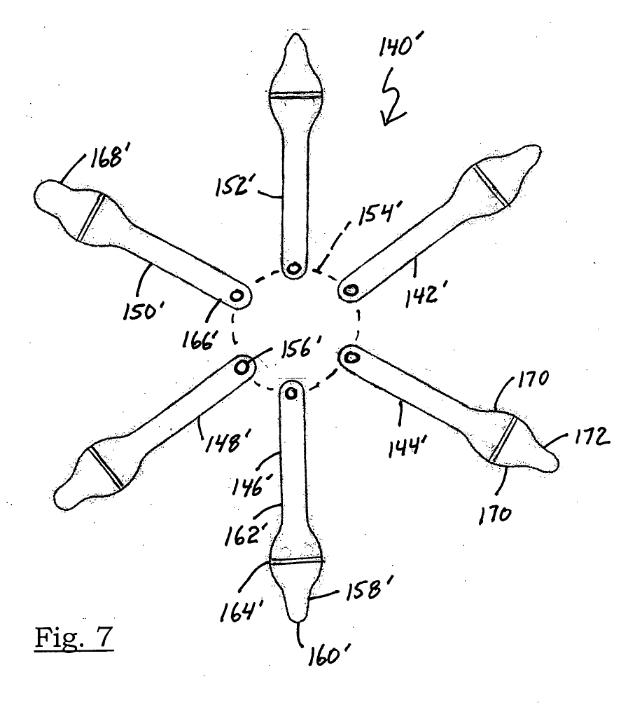

FIG. 7 shows a set 140′ of glazing hand tools 142′, 144′, 146′, 148′, 150′ and 152′ removably engaged to each other via a fastener 154′. Fastener 154′ may be a key ring, a shoelace, a strip of leather or other fastener that can be quickly and readily opened to selectively take any of the hand tools 142′, 144′, 146′, 148′, 150′ and 152′ off of the fastener 154′. Fastener 154′ can directly or indirectly engage a hole 156′ formed in each of the hand tools of set 140′. Or fastener 154′ can directly or indirectly engage each of the hand tools of set 140′ in another way such that the tools of set 140′ can selectively be removed from the fastener 154′.

Each of the hand tools of set 140′ includes a body 158′ having a rounded tip 160′. Each of the hand tools of set 140′ further includes a grip 162′ sandwiching body 158′.

Body 158′ includes the features of body 12 except that body 158′ has a single head 168′, except that body 158′ is includes an elliptical portion 170 closer to end 160′ than end 166′, and except that body 158′ includes hole 156′. Body 158′ is set entirely along a straight axis, like body 12. Like body 12, body 158′ is resilient such that body 158′ can be flexed somewhat when gripping and bending ends 160′ and 166′ relative to each other, and body 158′ is preferably formed of a plastic.

Grip 162′ includes the features of grip 14′, except that grip 162′ extends wholly to one end (end 166′) of its respective tool, except that grip 162′ covers generally about one-half of elliptical portion 170, except that grip 162′ includes hole 156′, and except that grip 162′ includes a tapered portion 164′. Like grip 14, grip 162′ is engaged on both sides or faces of body 158′, is preferably formed of a closed cell foam so as to be resilient and compressible, confronts rounded tip 160′, and is spaced from rounded tip 160′.

It should be noted that each of the grips 162′, like grips 14 of different hand tools, can be color coded, with respective colors being associated with respective radii of the rounded tip 160′. In other words, each of the tools of hand tool set 140′ includes a rounded tip 160′ with a different radius and each of the tools of hand tool set 140′ includes a grip 162′ of a different color.

It should be noted that each of the hand tools of set 140′ includes an operating end (rounded tip or proximal end 160′) and a fastened end (distal or apertured end 166′). Ends 160′, 166′ are aligned and are found on the same axis. The entirety of grip 162′ is on the same axis of head 168′ of body 158′. Such provides a more efficient glazing action where relatively great pressure is exerted for operation (as compared with a caulking action where relatively less pressure is exerted for operation).

It should be noted that each of the hand tools of set 140′ can be used for glazing (or another operation) while engaged on fastener 154′ or while disengaged from fastener 154′ and standing alone.

It should be noted that any of the rounded tips 160, 160′ of the hand tools of each of the sets 140, 140′ can be selected from any of the rounded or sharp tips of hand tools 10, 60, 80 and 98.

It should be noted that heads 168′ of the hand tools of set 140′ have generally two portions. One portion is about one-half of the elliptical portion 170. The other portion includes the rounded tip 160′ and includes a pair of opposing tapering edges 172 that lead into rounded or convex tip 160′.

What is claimed is:

1. A hand tool, comprising:
a) a body comprising a main body portion and at least a first head, with the first head making up a first end of the body, with said first head comprising a tip, with said tip being one of a sharp tip and rounded tip whereby the hand tool can act upon at least one of a relatively hard surface and relatively soft surface, with said main body portion having a pair of opposing surfaces; and
b) a grip sandwiching at least a section of the main body portion, with the grip terminating short of said first head so as to expose said first head, with the grip engaging opposing surfaces of the main body portion, and with said grip being resilient and compressible by hand.

2. The hand tool of claim 1, wherein said grip comprises grip portions, with each of the grip portions being disposed entirely in a respective single plane, wherein the main body portion is disposed entirely in a respective single plane, and wherein said first head is disposed entirely in the plane of the main body portion.

3. The hand tool of claim 1, wherein said grip comprises foam.

4. The hand tool of claim 1, wherein said grip comprises closed cell foam.

5. The hand tool of claim 1, wherein said first head includes a pair of edges, with each of the edges of said pair running tangentially into an edge of said grip.

6. The hand tool of claim 1, wherein said grip includes a C-shaped edge portion that confronts said first head.

7. The hand tool of claim 1, wherein the first head includes said rounded tip, with said rounded tip including a smooth edge portion to smooth and shape sealant.

8. The hand tool of claim 7, and further comprising a second head making up a second end of the body, wherein the second head includes said rounded tip, with said rounded tip including a smooth edge portion to smooth and shape sealant.

9. The hand tool of claim 1, wherein the first head includes said rounded tip, with said rounded tip including a convex smooth edge portion running laterally.

10. The hand tool of claim 9, and further comprising a second head making up a second end of the body, wherein the second head includes said rounded tip, with said rounded tip including a convex smooth edge portion running laterally.

11. The hand tool of claim 1, wherein the first head includes said sharp tip.

12. The hand tool of claim 11, and further comprising a second head making up a second end of the body, wherein the second head includes said sharp tip.

13. The hand tool of claim 12, wherein the first head includes a pair of blades tapering toward the tip and wherein the second head includes a claw.

14. The hand tool of claim 1, and further comprising a second head making up a second end of the body, wherein each of the first and second heads includes said rounded tip, with said rounded tip including a convex smooth edge portion running generally laterally, with the convex smooth edge portion of the first and second heads having different radii to smooth and shape sealant into concave shapes having greater and lesser radii.

15. The hand tool of claim 1, and further comprising a second head making up a second end of the body, wherein the body is generally a flat piece of plastic such that the main body portion and first and second heads are also part of the generally flat piece of plastic, and with the generally flat piece of plastic being resilient.

16. The hand tool of claim 1, wherein the body is formed of metal.

17. The hand tool of claim 1, wherein the first head comprises a first edge portion and a second edge portion, with the first and second edge portions being disposed at generally ninety degrees relative to each other, and with the first and second edge portions having a juncture therebetween.

18. The hand tool of claim 1, and further comprising a fastener for engaging a set of said hand tools, wherein said body includes a second end, wherein the second end of the body is adaptable for engagement to said fastener, wherein each of the hand tools of said second set includes a rounded tip, and wherein at least two of said hand tools of said set include rounded tips of different radii.

19. A hand tool, comprising:
a) a body comprising a main body portion, a first head, and a second head, with the first and second heads opposing each other, with the first and second heads making up opposing ends of the body, with each of the first and second heads comprising a rounded tip;
b) a resilient grip sandwiching at least a section of the main body portion, with said resilient grip terminating short of the first and second heads so as to expose the first and second heads, with the resilient grip being compressible by hand; and
c) wherein each of said rounded tips includes a convex smooth edge portion running generally laterally, with the convex smooth edge portion of the first head having a radius different from the convex smooth edge portion of the second head such that said hand tool can smooth and shape sealant into concave shapes having greater and lesser radii.

20. A hand tool set, comprising:
a) a first hand tool that comprises:
i) a body comprising a main body portion and first and second heads, with the body being a metal piece such that the first and second heads are also metal;
ii) a grip sandwiching at least a section of the main body portion, with the grip confronting each of the first and second heads; and
iii) with each of the first and second heads having a sharp tip, with the first head having a pair of knife edges tapering toward said tip, and with the second head being a claw; and
b) a second hand tool that comprises:
i) a body comprising a main body portion and first and second heads, with the body being a flat piece of plastic such that the main body portion and first and second heads are part of said generally flat piece of plastic;
ii) a grip sandwiching at least a section of the main body portion, with the grip confronting each of the first and second heads; and
iii) with each of the first and second heads having a smooth edge portion to smooth and shape sealant, with said smooth edge portion comprising a convex smooth edge portion running generally laterally;
c) whereby the first hand tool can prepare a surface and the second hand tool can repair said surface.
